(19) United States
(12) Patent Application Publication
(10) Pub. No.: US 2013/0007196 A1
(43) Pub. Date: Jan. 3, 2013

(54) Connectionless Operation in a Wireless Network

(76) Inventors: Frank M. Alfano, Wheaton, IL (US); Deborah L. Barclay, Winfield, IL (US)

(21) Appl. No.: 13/173,674

(22) Filed: Jun. 30, 2011

(51) Int. Cl. G06F 15/16

(52) U.S. Cl. 709/217

(57) ABSTRACT

An example method is executed on at least one of Serving GPRS Support Node (SGSN), an enhanced SGSN (eSGSN), a Packet Data Serving Node (PDSN), Serving Gateway (SG), or a computer network node and includes receiving a data message from a connectionless device, the data message comprising at least one of a device class identifier and an application class identifier. The method further includes forwarding the data message to an application wherein the data message is forwarded based on at least one of the device class identifier and application class identifier.

### TECHNICAL FIELD

This invention relates generally to communicating data to/from a connectionless device or class of connectionless devices, and more particularly to communicating data to/from a connectionless device or class of connectionless devices in a connectionless manner.

### BACKGROUND

As technology associated with wireless communications has improved, wireless devices have been integrated with host equipment to communicate information concerning the host equipment in order to more efficiently manage business operations. For example, a wireless device may be integrated with a gas meter, and information concerning gas usage tracked by the meter may be communicated by the gas meter via the wireless device to a gas company computer application. Communicating data in this manner alleviates the need for the gas company to send someone to read the meter. Further, this information may be collected at a central location of the company's choosing which eases the process of assembling and analyzing data. This use of a wireless device may extend to other equipment, such as vending machines, parking meters, medical devices and other equipment that may want to communicate information to a central location. In each of these cases, the equipment may want to send a burst of data at infrequent intervals. Also, the equipment may be immobile or move infrequently within the same public land mobile network (PLMN).

One way to communicate this data would be to use a standard wireless network connection between the host equipment comprising a wireless device and the computer application. When communicating in this manner if the wireless device wants to communicate data to the application, the wireless device establishes a bearer channel over which the data is sent. In establishing a bearer channel, the wireless device and elements of the wireless network exchange numerous messages and maintain a call state context in order to successfully communicate the data to the application. In some instances, the information associated with the signaling and overhead that occurs when establishing a bearer channel far exceeds the amount of data that is communicated. Also, in the downlink direction, if the application wants to send data to the wireless device, the wireless network may have to page the mobile device to establish a bearer channel. Sometimes this paging covers multiple paging or tracking areas which requires the wireless network to maintain state information about where the wireless device has been paged and the area from which the mobile device acknowledges a page. Again, the amount of overheard associated with locating the mobile device and establishing a bearer channel may far exceed the amount of data that is ultimately communicated to the wireless device.

### SUMMARY

One implementation encompasses a method. The method executed on at least one of Serving GPRS Support Node (SGSN), an enhanced SGSN (eSGSN), a Packet Data Serving Node (PDSN), Serving Gateway (SG), or a network node comprising, the method comprising receiving a data message from a connectionless device, the data message comprising at least one of a device class identifier and an application class identifier. The method further comprises forwarding the data message to an application where the data message is forwarded based on the device class identifier and application class identifier.

In another embodiment there is provided a network node. The network node is configured to receive a data message from a connectionless device, the data message comprising at least one of a device class identifier and an application class identifier. Further, the network node is configured to forward the data message to an application based on the device class identifier and application class identifier.

A further implementation encompasses a network node configured to receive a data message from an application and communicate the data message to a connectionless device or class of connectionless devices via a page message. The page message is communicated by the network node to the connectionless device or class of connectionless devices based on a device class identifier and an application class identifier.

### DESCRIPTION OF THE DRAWINGS

Features of example embodiments will become apparent from the description, the claims, and the accompanying drawings in which:

FIG. 1 is a representation of a network that a connectionless device may use in communicating a data burst to an application;

FIG. 2 is a representation of an example message flow of a connectionless device with a fixed IP address communicating data to an application;

FIG. 3 is a representation of an example message flow of a connectionless device without an IP address communicating data to an application;

FIG. 4 is a representation of an example message flow of a connectionless device requesting an IP address from a first hop;

FIG. 5 is a representation of an example message flow of an application communicating data to a connectionless device;

FIG. 6 is an example logic flow diagram for communicating data from a connectionless device to an application; and

FIG. 7 is an example logic flow diagram for communicating data from an application to a connectionless device.

### DETAILED DESCRIPTION

Typically when a mobile device communicates data to an application, the mobile device establishes a bearer channel or some other type of channel that requires maintaining a stateful connection, in other words, a connection that has associated state data (a context) that is updated and maintained as the connection is used. These stateful connections may extend through different components of equipment that reside in a service provider's network. When, however, the device is only going to use a connection to send a burst of data, there may be no need to maintain a stateful connection. When the data is sent over a typical wireless network, the data burst may require that the network setup a stateful connection. Sending data to an application without the need for a stateful connection would save network resources. The connectionless device and the application should be able to communicate data in a connectionless manner. In other words, the application and connectionless device should be able to communicate data without the network maintaining state information (a context) concerning the transactions between connectionless device and the application. Herein, communicating data in a connectionless manner means that data or data messages may be received and sent from network nodes without the need for the network nodes to maintain state information (a context).

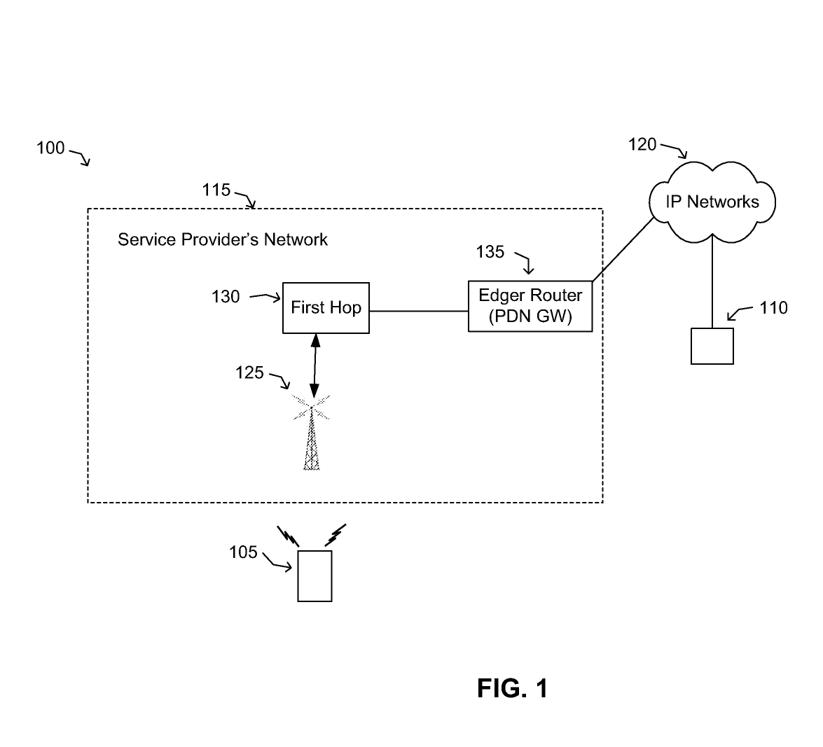

Turning to FIG. 1, there is depicted a network 100 that a connectionless device 105 may use in communicating a data burst to an application 110. As described, the connectionless device 105 may be an immobile device, such as a vending machine, a gas meter, home security system, or medical monitoring device, where the connectionless device 105 may include a wireless component that enables the connectionless device 105 to communicate with a wireless network 115. The wireless network 115 may be a 3rd Generation Partnership Project (3GPP) network, a Long Term Evolution (LTE) network or any other type of network that enables the connectionless device 105 to establish a wireless connection with the network 115.

The wireless network 115 may be comprised of a number of components that may be used in routing information received from wireless devices to one or more Internet Protocol (IP) networks 120 that may in-turn be communicatively coupled with the application 110. The wireless network 115 may be a network that a service provider administers. The network 115 may comprise a base site 125 that provides a termination point for a wireless connection with the connectionless device 105. The base site 125 may also be communicatively coupled with a first hop router 130 that is further communicatively coupled with an edge router 135. The first hop 130 may be a wireless computer network node responsible for mobility management and packet data routing. In a 3GPP network, the first hop 130 may be a Serving GPRS Support Node (SGSN), an enhanced SGSN (eSGSN), or a Packet Data Serving Node (PDSN). In an LTE network the first hop 130 may be a Serving Gateway (SG). In other types of networks, the first hop 130 may be any computer network node used in support of packet data routing. In a 3GPP network the edge router 135 may be a Gateway GPRS Support Node (GGSN), and in an LTE network the edge router 135 may be a Packet Data Network Gateway (PDN GW). In other types of networks, the edge router 135 may be any computer network node used in support of providing the network 115 with a point of exit to IP networks that may reside external to the wireless network 115. This is not an exhaustive depiction of elements that may comprise the service provider's network 115, there may be other elements and functions not pictured that are still part of the network 115. The description herein is limited to those components of the network 115 that are most referenced in describing establishing communication between a connectionless device 105 and an application 110.

The application 110, in one example, may reside outside the service provider's network at a location accessible to a corporation for the purposes of receiving data from the application 110. For example, when the connectionless device 105 is a gas meter, the application 110 may be accessible to a gas company for the purpose of downloading gas use statistics that may be collected by the connectionless device 105. The connectionless device 105 may communicate information to the application 110 via a service provider's network 115, and the application 110 may make that data available to users, such as the corporation administering the application. This may entail the connectionless device 105 sending data on a common uplink channel that results in the data being communicated to the application via a message flow that occurs among the elements of the described networks. In some embodiments, the connectionless device 105 may have a fixed IP address that may be used by the application 110 or the network 115 to identify the connectionless device 105.

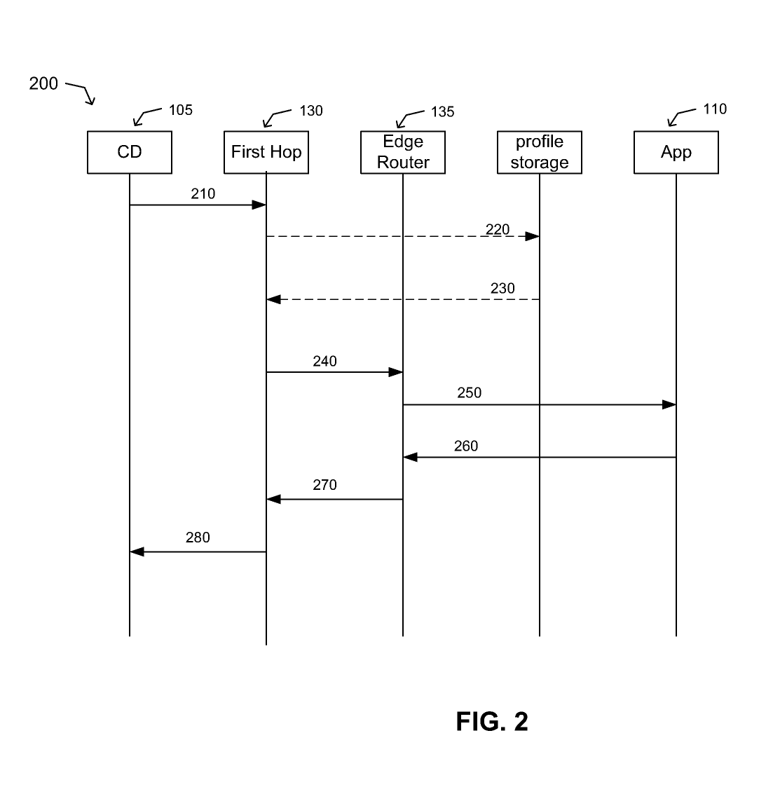

Turning now to FIG. 2, there is depicted one example of a message flow diagram 200 of a connectionless device with a fixed IP address communicating data to an application. When the connectionless device 105 has information to communicate, the connectionless device 105 may send 210 the data in a data message, such as a data delivery request message to the first hop 130. The connectionless device 105 may communicate data over common channels. In other words, the connectionless device 105 may send messages without establishing a bearer channel. Thus, the data delivery request may be sent over a common control uplink channel such as a random access channel or any other channel that allows for communicating uplink data without establishing a bearer channel.

In an embodiment, the data delivery request message may comprise a unique device identifier, a device class identifier, an application class identifier, an IP address and application data. The unique device identifier may be an identifier that uniquely identifies the connectionless device as a device with a specific application, or set of applications that utilize connectionless services. An application that receives the data delivery request message may use the unique device identifier to determine which device is sending the data. The device class identifier may identify the class of the connectionless device. For example, a device class may be gas meters, vending machines, or medical devices. The application class identifier may identify the application class associated with the data delivery request. For example, the application class may be device status information, or application information, where device status information may indicate that a device has gone off-line, and application information may indicate that the application data comprises information that may be used for application purposes. The IP address may be a static IP address of the device, which may be, for example, either an IPv4 or an IPv6 address. Although in the embodiment depicted use of an IP address, in other embodiments the connectionless device may use other kinds of addresses. The application data may be data that the application uses in performing its functions. When, for example, the connectionless device is a vending machine, the application data may include the number of items remaining in a vending machine, the remaining number of items for particular vending slot, and the like.

As described, the connectionless device 105 may communicate a data delivery request message to the first hop 130. The first hop 130 may examine the message to determine the device class identifier and application class identifier of the sending communication device 105. An application profile may be associated with each device class identifier, application class identifier, or combination of the device class identifier and application class identifier. The application profile may include information, such as, a data characteristics variable, application routing information and network authentication variables. The data characteristics may include quality of service requirements and information related to the volume of data the connectionless device may transmit. The application routing information may include information needed to route data to an application. This routing information may include, for example, the IP address of the destination application, the IP address of a gateway that may be used to access the application and any other information needed to route data from the first hop 130 to the application 110. The network authentication variables may include information needed to authenticate the connectionless device, such as, for example, shared keys.

The first hop 130 may store a copy of the application profile in memory. When, however, the first hop 130 receives a data delivery request message including a device class identifier and application identifier associated with an application profile that is not stored in memory, the first hop 130 may query 220 a profile storage device for the application profile. The profile storage device may return 230 the application profile associated with the received device class identifier and application identifier. (The dashed lines for 220 and 230 indicate that these messages are optional.) In some embodiments, the first hop 130 may authenticate the connectionless device 105 at this point. The authentication may be performed using the network authentication variables comprising the application profile, and the authentication variables may include shared secret keys and other authentication data. The first hop 130 may also validate the application data included in the data delivery request. Validating the application data may include verifying that the application data does not exceed the volume of data allowed as indicated by the data characteristics variable. Also as part of validating the application data, the first hop 130 may ensure that application data is delivered with the quality of service indicated by the data characteristics variable. If the amount of application data exceeds the volume of data allowed, or the application data cannot be delivered with the required quality of service, the first hop 130 may discard the data delivery request.

Based on the routing information comprising the application profile, the first hop 130 may communicate 240 the data delivery request message to the edge router 135 in a connectionless manner. The edge router 135 may forward 250 the data delivery request message to the application 110, also in a connectionless manner. When communicating the data delivery request message to the application 110, the first hop 130 and the edge router (or any other intermediate network node) do not maintain state information associated with sending the uplink data to the application 110. Also, because the data delivery request message was originally sent over a common uplink channel, the first hop 130 also does not maintain state information associated with delivering data to the connectionless device 105. Because the first hop 130 and edge router do not have to maintain state information when delivering data to the application 110, the first hop 130 may save resources associated with setting up and maintaining stateful connections with the connectionless device 105 and the application 110.

Depending on how the application 110 is configured, the application 110 may or may not respond to the data delivery request message. When the application responds, the application 110 may send 260 a data delivery acknowledgement message to the edge router 135 which may forward 270 the message to the first hop 130 in a connectionless manner. The first hop 130 may then forward 280 the message to the connectionless device 105 in a connectionless manner. The application 110 may be aware of the address of the edge router because the application 110 received the IP address of the edge router 135 in the data delivery request sent at 250. Alternatively, the edge router 135 may have an address that is known to the application 110. Regardless, the edge router 135 forwards the data delivery acknowledgement to the first hop 130. The edge router 135 may forward the message to the first hop 130 based on the IP address of the connectionless device 105.

As previously explained, there may be a significant amount of overhead associated with establishing a bearer channel with a connectionless device. Thus, forwarding 280 the data delivery acknowledgement to the connectionless device 105 in a connectionless manner may provide a way to avoid unwanted overhead. One way of communicating a message to a wireless device in a connectionless manner is through the use of a common downlink channel, such as a paging channel. A page message typically includes a mobile identification number (e.g., MIN or mobile equipment identification number (MEID)) which indicates the device to which the message is addressed. Because messages are communicated to/from the connectionless device 105 based on a device class and/or application class identifier, the connectionless device 105 may not have an associated mobile identifier. When there is not a mobile identifier associated with the connectionless device 105, the first hop 130 may use a generic mobile identifier that is used to communicate page messages to all connectionless devices of a particular device class. After receipt of a page message comprising the generic mobile identifier, a recipient connectionless device may examine the data delivery acknowledgement message for an IP address, unique device identifier or any other unique identifier that indicates that the page message is addressed to the recipient connectionless device. The data delivery acknowledgement message may contain data that triggers some response from the device 105 or set of devices. In this way the data delivery acknowledgement message may also be used to initiate a transaction back to the wireless device.

In other embodiments, the application 110 may want to communicate a broadcast message to all the devices of a particular device class and/or application class identifier. This message, for example, may provide the devices of the class with a generic message, such as an updated address for the application 110 or may contain an application specific code that tells the device(s) 105 to take some specific action. The application may communicate the data delivery broadcast message at a time of its choosing without prompting from a connectionless device. The first hop 130 may address a page message comprising the data delivery broadcast message to a class of devices using a generic mobile identity, and the recipient connectionless device may examine the data delivery broadcast message to determine that the message is a generic message that the device should read.

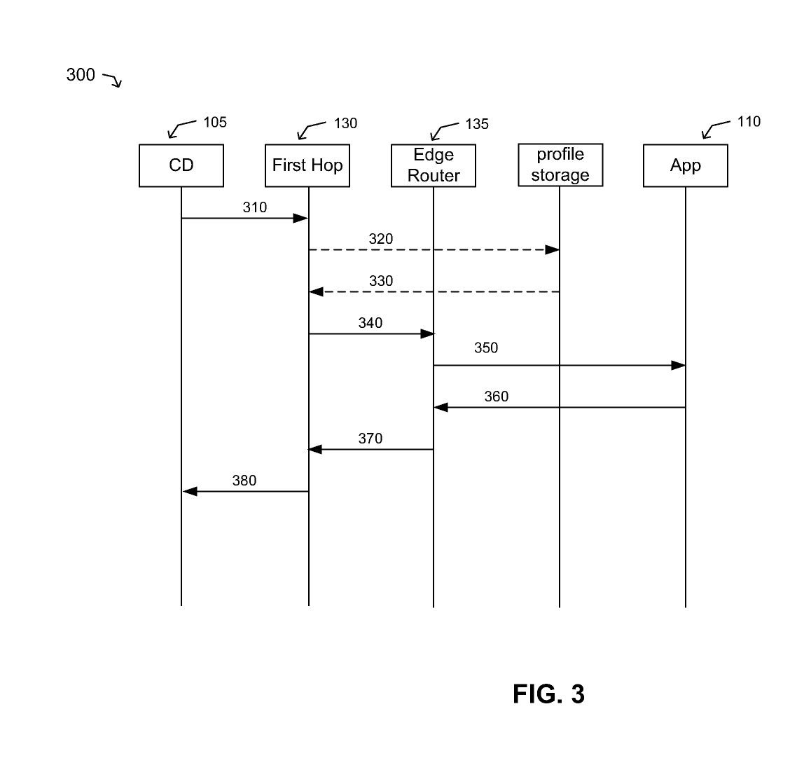

Turning now to FIG. 3, there is depicted an example message flow diagram 300 of a connectionless device 105 without a fixed IP address communicating a data message to an application. As before, the connectionless device 105 may communicate 310 a data delivery request message using an uplink common channel. The first hop 130 may receive the data delivery request message which includes a unique device identifier, a device class identifier, an application class identifier and application data. Because the connectionless device 105 does not have an associated IP address, the data delivery request may not include the IP address field. When the first hop 130 does not have a local copy of an application profile associated with either the device class identifier and/or the application class identifier, the first hop 130 may query 320, 330 a profile storage device for the application profile. Based on routing information comprising the application profile, the first hop 130 may communicate 340 the data delivery request message to the edge router 135 in a connectionless manner. The edge router 135 may forward 350 the message to the application 110 in a connectionless manner. The application 110 may determine which connectionless device sent the message based on the unique device identifier comprising the data delivery request message. When the application 110 responds to the data delivery request message, the application 110 may communicate 360 a data delivery acknowledgement message to the edge router 135, which forwards 370 the message to the first hop 130. The first hop 130 may communicate the data delivery acknowledgement message in a connectionless manner on a common downlink channel, such as a paging channel, using the unique device identifier as a mobile identifier so that the connectionless device 105 recognizes that the data delivery acknowledgement message is addressed to it.

In another embodiment, the connectionless device 105 may not have a fixed IP address, but the first hop 130 may allocate an IP address that the connectionless device 105 may use to send data to the application 110. Once the connectionless device 105 is finished using the IP address, the connectionless device 105 may signal the first hop 130 that the address is free. The first hop 130 may maintain a list of available IP addresses, or the first hop 130 may query another network node (not pictured) which tracks IP addresses that are in use and allocates free IP addresses for the first hop 130 to pass to the connectionless device 105.

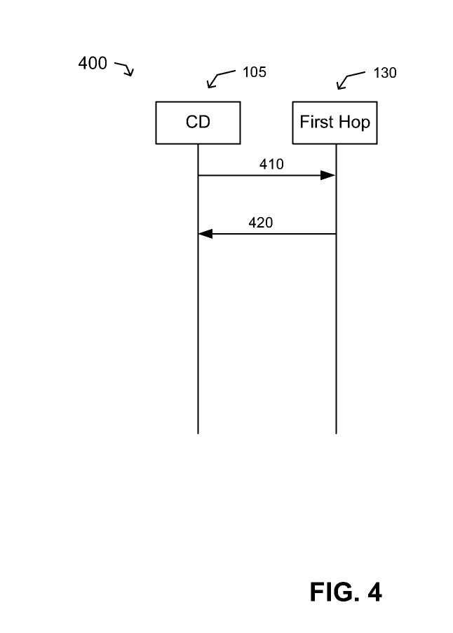

Turning now to FIG. 4, there is depicted one example of a message flow associated with a first hop allocating an IP address for a connectionless device. When the connectionless device 105 does not have an assigned IP address and the connectionless device 105 wants to receive an IP address, the connectionless device 105 may send 410 an IP address request message on an uplink common channel to the first hop 130. In response, the first hop 130 may communicate 420 an IP address acknowledge message comprising an allocated IP address to the connectionless device. At this point, the connectionless device 105 has an IP address to use in communicating data to the application 110. The message flow may proceed as shown in FIG. 2, except that after the connectionless device 105 has received a data delivery acknowledgement, or the connectionless device 105 has timed out waiting for a data delivery acknowledgement, the connectionless device may choose to free the IP address by communicating a message to the first hop 130 indicating that the IP address may be freed.

In another embodiment, the first hop 130 may operate in a manner similar to a network address translation (NAT) server. When operating in this manner the first hop 130 may allocate a private IP address to the connectionless device 105, but the first hop 130 may transmit a public IP address to the application 110. The application 110 may communicate with the connectionless device 105 using the public address, but the first hop 130 may intercept and translate the public address to the private address that the connectionless device 105 is assigned.

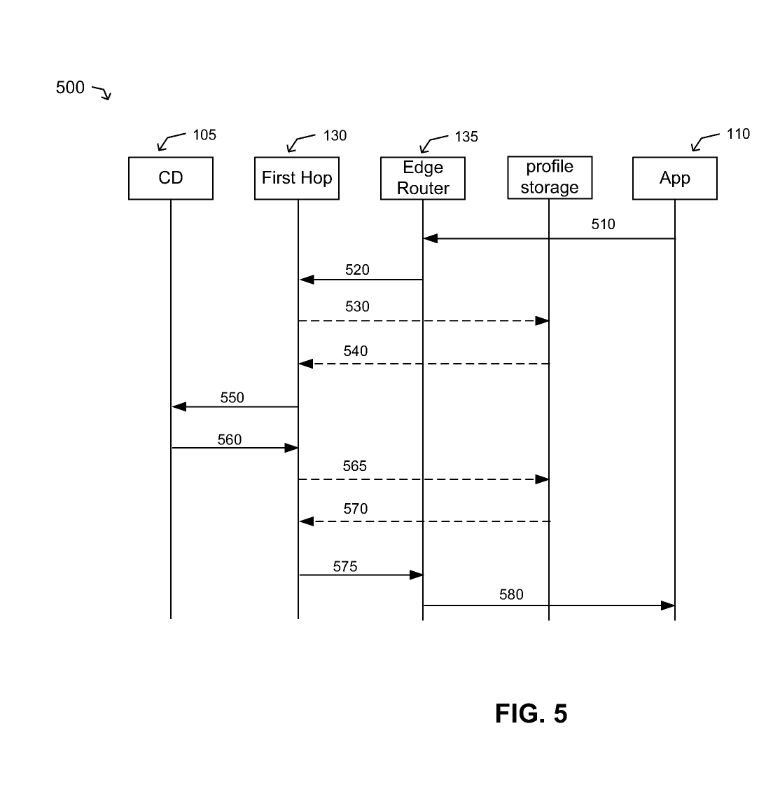

Turning now to FIG. 5, there is depicted an example message flow diagram that may be associated with an application sending data to a connectionless device. The application 110 may send the data at a time of its choosing in a data message, such as a data delivery request message. That is, the data delivery request may be sent independent of data being sent from the connectionless device 105 to the application 110. The data delivery request that the application 110 sends may comprise the same parameters as previously described, that is, a unique device identifier, a device class identifier, an application class identifier, an IP address of the connectionless device and application data. Because the IP address of the edge router 135 may be known to the application 110, the application 110 may know to communicate 510 a data delivery request message to the edge router 135 which forwards 520 the message to the first hop 130 based on at least one of the IP address of the data delivery request, the unique device identifier, device class identifier or application class identifier. The first hop 130 may retrieve 530, 540 a device profile from a separate network device or the first hop 130 may have the device profile stored in memory. The device profile may be associated with each device class identifier, application class identifier, or combination of device class identifier and application class identifier. The device profile may include information, such as, one or more of a data characteristics variable, paging information such as the location area that the device(s) may be paged, network authentication variables, and the like, or a combination or these characteristics, informations and variables. The paging information may include the last known area of the connectionless device 105. Because the device 105 is typically immobile, a service provider may enter the last known area and the area may remain fixed. In other embodiments, the last known area may be updated in a manner similar to a typical mobile device. The data characteristics variable may include quality of service requirements and information related to the volume of data that the connectionless device may receive. If the first hop 130 cannot ensure the quality of service in delivering the data to the connectionless device 105, or if the amount of application data exceeds the volume of data allowed, the first hop 130 may discard the data delivery request. The network authentication variables may comprise shared keys that may be used to authenticate the recipient connectionless device 105 or the application 110.

The first hop 130 may determine that the data delivery request message is to be communicated to either the connectionless device 105 or a class of connectionless devices, and based on this determination the first hop may accordingly communicate 550 the data delivery request. When the data delivery request is addressed to the specific connectionless device 105 and the connectionless device 105 does not have an associated mobile identifier, the first hop 130 may use a generic mobile identifier to communicate page messages to all connectionless devices of a particular device class or application class. After receipt of a page message comprising the generic mobile identifier, the connectionless device 105 may examine the data delivery request message for an IP address, unique device identifier or any other unique identifier that indicates that the page message is addressed to the connectionless device 105. In an embodiment, the connectionless device 105 may send 560 a data delivery acknowledge message in response to the data delivery request. Again, the first hop may optionally retrieve an application profile 565, 570 when it does not have an application profile stored in memory. The first hop 130 may forward 575 the data delivery acknowledge message to the edge router 135 which forwards 580 the message to the application 110.

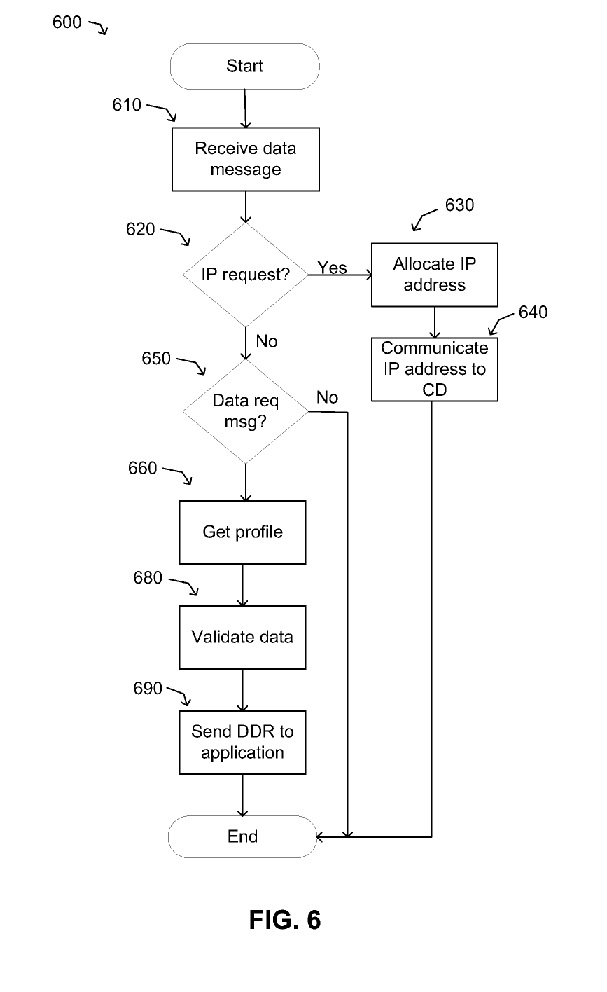

Turning now to FIG. 6, there is depicted an example flow chart diagram 600 that may represent a method for communicating data from a connectionless device to an application. In an embodiment, the method 600 may be implemented in a first hop, such as the first hop 130. In other embodiments, the method may execute on other network nodes, or the method may be distributed among a plurality of network nodes. At 610, a connectionless data message is received. When the data message is an IP request message 620, an IP address is allocated 630, the IP address is communicated to the connectionless device 640 in an IP address acknowledge message and the method 600 ends. When the data message is not an IP address request, it is determined if the data message is a data delivery request message 650. When the data message is not a data delivery request, the method 600 ends. When the data message is a data delivery request, the first hop router may retrieve the application profile. Data comprising the data delivery request may be validated 680 to make sure the data meets the requirements of the data characteristics variable of the application profile. Further, the data delivery request may be delivered to the application 690 via an edge router.

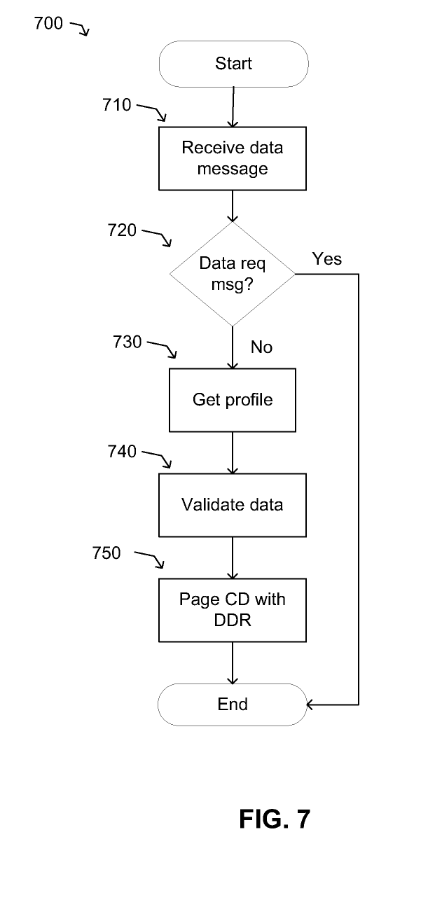

Turning now to FIG. 7, there is depicted an example logic flow diagram 700 that may represent a method for communicating a data message from an application to a connectionless device. In an embodiment, the method 700 may be implemented in a first hop, such as the first hop router 130. In other embodiments, the method may execute on other network nodes, or the method may be distributed among a plurality of network nodes. At 710, a connectionless data message is received. When it is determined 720 that the data message is not data delivery request message, the method 700 ends. When it is determined 720 that the data message is a data delivery request, the addresses of the sender may indicate that this is a message intended for a connectionless device. That is, when the sender of the data delivery request is either the application or the edge router 135, the final destination of the data delivery request may be the connectionless device 105. The first hop router may retrieve 730 a device profile from a separate network device or the device profile may be stored in memory of the first hop router. Data comprising the data delivery request may be validated 740 to make sure the data adheres to the requirements of a data characteristics variable of the device profile. The data delivery request may be communicated 750 to the connectionless device through paging or through other uses of a common downlink channel. In one embodiment, a page message is addressed to a specific connectionless device. In other embodiments, a page message is addressed to a class of connectionless devices based on at least one of a device class identifier or an application class identifier comprising the data delivery request message.

The apparatus 130 in one example comprises a plurality of components such as one or more of electronic components, hardware components, and computer software components. A number of such components can be combined or divided in the apparatus 130. An example component of the apparatus 130 employs and/or comprises a set and/or series of computer instructions written in or implemented with any of a number of programming languages, as will be appreciated by those skilled in the art. The apparatus 130 in one example comprises any (e.g., horizontal, oblique, or vertical) orientation, with the description and figures herein illustrating one example orientation of the apparatus 130, for explanatory purposes.

The apparatus 130 in one example employs one or more computer-readable non-transitory signal-bearing media. The computer-readable non-transitory signal-bearing media store software, and/or include firmware for performing one or more portions of one or more implementations. Examples of a computer-readable non-transitory signal-bearing medium for the apparatus 130 comprise a recordable data storage medium. The computer-readable non-transitory signal-bearing medium for the apparatus 130 in one example comprise one or more of a magnetic, electrical, optical, biological, and atomic data storage medium. Example non-transitory computer-readable signal-bearing medium include floppy disks, magnetic tapes, CD-ROMs, DVD-ROMs, hard disk drives, and electronic memory.

The steps or operations described herein are just for example. There may be many variations to these steps or operations presented herein in association with various embodiments. For instance, the steps may be performed in a differing order, or steps may be added, deleted, or modified.

Although example implementations of the embodiments have been depicted and described in detail herein, it will be apparent to those skilled in the relevant art that various modifications, additions, substitutions, and the like can be made without departing from the spirit of the disclosed embodiments and these are therefore considered to be within the scope of the following claims.

What is claimed is:

1. A method, executed on at least one of a Serving GPRS Support Node (SGSN), an enhanced SGSN (eSGSN), a Packet Data Serving Node (PDSN), a Serving Gateway (SG), or a computerized network node comprising:
receiving a data message from a connectionless device, the data message comprising at least one of a device class identifier and an application class identifier; and
forwarding the data message to an application where the data message is forwarded based on one of the device class identifier, the application class identifier, or the device class identifier and application class identifier.

2. The method of claim 1, further comprising retrieving an application profile based on at least one of the device class identifier and the application class identifier, wherein the application profile comprises an address where the data message is forwarded.

3. The method of claim 2, further comprising validating application data comprising the data message, wherein the application data is validated based on a data characteristics variable of the application profile.

4. The method of claim 1, wherein the receiving and the forwarding of the data message are preformed in a connectionless manner.

5. The method of claim 1, further comprising receiving the data message on a common uplink channel.

6. The method of claim 1, further comprising receiving a data delivery acknowledge message and forwarding the data delivery acknowledge message to the connectionless device based on an IP address included in the data delivery acknowledge message.

7. The method of claim 6, further comprising forwarding the data delivery acknowledge message in a connectionless manner on a common downlink channel.

8. A network node configured to receive a data message from a connectionless device, the data message comprising at least one of a device class identifier and an application class identifier; and
wherein the network node is configured to forward the data message to an application based on one of the device class identifier, application class identifier, or the device class identifier and application class identifier.

9. The network node of claim 8, wherein the network node is further configured to retrieve an application profile based on one or more of the at least one of the device class identifier and application class identifier, where the application profile comprises an address where the data message is forwarded.

10. The network node of claim 9, wherein the data message comprises application data, and the network node validates the application data based on a data characteristics variable included in the application profile.

11. The network node of claim 8, wherein the network node is further configured to allocate an IP address for the connectionless device, and communicate the IP address to the connectionless device.

12. The network node of claim 11, wherein the network node is further configured to receive a data message including the allocated IP address.

13. The network node of claim 8, wherein the network node resides within a wireless network and the application resides in a network that is external to the wireless network.

14. The network node of claim 8, wherein the network node receives and forwards the data message in a connectionless manner.

15. The network node of claim 8, wherein the network node pages a class of connectionless devices based on a mobile identifier that identifies the class of connectionless devices.

16. The network node of claim 8, wherein the data message is received on a common up link channel.

17. A network node configured to receive a data message from an application and communicate the data message to a connectionless device or class of connectionless devices via a page message, wherein the page message is communicated to the connectionless device or class of connectionless devices based on one of a device class identifier, an application class identifier, or the device class identifier and the application class identifier.

18. The network node of claim 17 wherein at least one of the device class identifier or the application class identifier are represented by a generic mobile identifier.

19. The network node of claim 17 wherein network node is configured to retrieve a device profile based on at least one of the device class identifier and the application class identifier.

20. The network node of claim 17 wherein the network node is configured to validate data included in the data message based on at least one authentication variable included in the device profile.
